(19) United States
(12) Patent Application Publication
(10) Pub. No.: US 2019/0119911 A1
(43) Pub. Date: Apr. 25, 2019

(54) BIRD EXCLUSION DEVICE

(71) Applicant: War Bird Manufacturing, Inc., Tinton Falls, NJ (US)

(72) Inventor: RICHARD BRETT MADDEN, POINT PLEASANT BEACH, NJ (US)

(21) Appl. No.: 16/170,610

(22) Filed: Oct. 25, 2018

Related U.S. Application Data
(63) Continuation-in-part of application No. 29/631,754, filed on Jan. 2, 2018.
Application No. 29/631,754 is a continuation-in-part of application No. 29/631,756, filed on Jan. 2, 2018.
(60) Provisional application No. 62/576,977, filed on Oct. 25, 2017.

(51) Int. Cl. E04B 1/72; A01M 29/32; E04D 13/00

(52) U.S. Cl. CPC E04B 1/72; E04D 13/004; A01M 29/32

(57) ABSTRACT

A bird exclusion device for preventing birds from alighting on ledges, the device formed from a base unit having a length, with a consistent cross-section throughout the length, the base unit including an elongate member, a foundation member, and a frontal member, all being planar and extending from a common junction, the foundation member and the frontal member forming an angle of approximately 90 degrees between one another, the elongate member extending at an angle from the foundation member of between approximately 15 degrees and approximately 75 degrees.

### CROSS-REFERENCE TO RELATED APPLICATIONS

The present application is a continuation-in-part application of U.S. Design patent application Ser. No. 29/631,754, entitled “BIRD EXCLUSION DEVICE,” filed Jan. 2, 2018, a continuation-in-part application of U.S. Design patent application Ser. No. 29/631,756, entitled “BIRD EXCLUSION DEVICE,” filed Jan. 2, 2018, and claims benefit of U.S. Provisional Patent Application Ser. No. 62/576,977, entitled “BIRD EXCLUSION DEVICE,” filed Oct. 25 ,2017, the disclosures of which are hereby incorporated by reference herein.

### BACKGROUND OF THE INVENTION

The present invention relates to bird exclusion devices, and specifically to bird exclusion devices adapted to prevent birds from alighting on ledges.

It is well known that birds tend to alight on horizontal ledges of buildings and other structures. Because of the unsanitary and unsightly conditions these circumstances cause, building and structure owners routinely employ safeguards to prevent such landings. Common bird deterrent devices, such as spikes, tension wire, and the like, may be employed. While these typically prevent landing, they are often unsightly, and many building owners prefer bird exclusionary devices such as bird netting or structural modifications. Among known structural modification are sloping devices which render alighting difficult. Existing sloping devices have drawbacks related to difficulties in installation and overall effectiveness, given that many sloping devices have crevices through which birds can gain purchase with their hindlimbs and still land.

### BRIEF SUMMARY OF THE INVENTION

It would therefore be advantageous to provide a sloping device which is easier to install and eliminates edges that birds can use to gain purchase upon landing.

In accordance with .a first embodiment of the present invention, there is provide a bird exclusion device comprising a base unit, the base unit comprising an elongate member, a foundation member, and a frontal member, all being planar and extending from a common junction; the foundation member and the frontal member forming an angle of approximately 90 degrees between one another. This device is referred to as Aspect 1.

In the device of Aspect 1, the elongate member may extend at an angle from the foundation member of between approximately 15 degrees and approximately 75 degrees.

In the device of Aspect 1, the base unit may have a length with a consistent cross-section throughout the length.

In the device of Aspect 1, the elongate member, the foundation member, and the frontal member may each have approximately equal thickness, with the common junction being built-up to a greater thickness.

In the device of Aspect 1, the elongate member may have a depth and the foundation member and the frontal member may have depths less than that of the elongate member.

In the device of Aspect 1, the elongate member may have a depth and the foundation member and the frontal member may have depths less than that of the elongate member, wherein the frontal member and the foundation member have different depths.

The device of Aspect 1 may further comprise an extender, the extender comprising a main portion extending from a connection portion, the connection portion adapted to connect to the elongate member.

The device of Aspect 1 may further comprise an extender, the extender comprising a main portion extending from a connection portion, the connection portion adapted to connect to the elongate member, wherein the connection portion comprises a pair of opposed fingers.

The device of Aspect 1 may further comprise an extender, the extender comprising a main portion extending from a connection portion, the connection portion adapted to connect to the elongate member, wherein the elongate member extends at a first angle from the foundation member, and the end member further comprises an end member, the end member angled relative to the main portion at a second angle, the first angle and the second angle having a sum equaling 90 degrees or approximately 90 degrees.

In the device of Aspect 1, the base unit may be formed from synthetic plastic polymer.

In the device of Aspect 1, each of the foundation member and the frontal member may include undersides having surface treatments increasing the surface area thereof.

The device of Aspect 1 may consist of the elongate member, the foundation member, and the frontal member.

In the device of Aspect 1, the elongate member may extend at an angle from the foundation member of approximately 45 degrees.

In another embodiment of the invention, a bird exclusion device comprises a base unit, the base unit having a length, with a consistent cross-section throughout the length; the base unit comprising an elongate member, a foundation member, and a frontal member, all being planar and extending from a common junction; the foundation member and the frontal member forming an angle of approximately 90 degrees between one another; and the elongate member extending at an angle from the foundation member of between approximately 15 degrees and approximately 75 degrees. This device is referred to as Aspect 2.

In the device of Aspect 2, the elongate member, the foundation member, and the frontal member may each have approximately equal thickness, with the common junction being built-up to a greater thickness.

The device of Aspect 2 may further comprise an extender, the extender comprising a main portion extending between an end member and a connection portion, the connection portion comprising a pair of opposed fingers adapted to connect to the elongate member.

In a further aspect of the invention, identified as Aspect 3, a method of forming a bird exclusion device comprises extruding a material to form a base unit, the base unit comprising an elongate member, a foundation member, and a frontal member, all being planar and extending from a common junction, the foundation member and the frontal member forming an angle of approximately 90 degrees between one another.

In the method of Aspect 3, the material may be synthetic plastic polymer.

In the method of Aspect 3, the elongate member, foundation member, and frontal member may each have approximately equal thicknesses with the common junction being built-up to a greater thickness.

In a still further aspect of the invention, identified as Aspect 4, a method of installing a bird exclusion device comprising a base unit having an elongate member, a foundation member, and a frontal member, all being planar and extending from a common junction, the foundation member and the frontal member forming an angle of approximately 90 degrees between one another, comprises: abutting the foundation member against the horizontal surface of a ledge; and abutting the frontal member against the lower vertical surface of a ledge.

The method of Aspect 4 may further comprise trimming the elongate member to form an end, and abutting the end against the upper vertical surface of the ledge.

In other aspects of the invention, items identified herein as accessories may be provided without a base unit. Accordingly, a mid-extender may be provided by itself, an end piece may be provided by itself, and/or a connector may be provided by itself.

In other aspects of the invention, kits of various components may be provided. xx

### BRIEF DESCRIPTION OF THE DRAWING FIGURES

The subject matter regarded as the invention is particularly pointed out and distinctly claimed in the concluding portion of the specification. The invention, however, both as to organization and method of operation, together with features, objects, and advantages thereof, will be or become apparent to one with skill in the art upon reference to the following detailed description when read with the accompanying drawings. It is intended that any additional organizations, methods of operation, features, objects or advantages ascertained by one skilled in the art be included within this description, be within the scope of the present invention, and be protected by the accompanying claims.

With respect to the drawings, FIG. 1 depicts a top perspective view of a bird exclusion device in accordance with a first embodiment of the invention, comprising a base unit, the broken lines thereof representing indeterminant length, the bird exclusion device being shown on a ledge depicted in additional broken lines to represent a common installation environment;

FIG. 2 depicts a bottom perspective view of the bird exclusion device shown in FIG. 1;

FIG. 3 depicts a right side view of the bird exclusion device shown in FIG. 1;

FIG. 4 depicts a left side view of the bird exclusion device shown in FIG. 1;

FIG. 5 depicts a front view of the bird exclusion device shown in FIG. 1;

FIG. 6 depicts a rear view of the bird exclusion device shown in FIG. 1;

FIG. 7 depicts a bottom view of the bird exclusion device shown in FIG. 1;

FIG. 8 depicts a top view of the bird exclusion device shown in FIG. 1;

FIG. 9 depicts a top perspective view of a first extender for optional use with the bird exclusion device shown in FIG. 1, the broken lines thereof representing indeterminant length;

FIG. 10 depicts a right side view of the first extender shown in FIG. 9;

FIG. 11 depicts a top perspective view of a bird exclusion device in accordance with a second embodiment of the present invention, the second embodiment comprising the first extender of FIG. 9 in use with the base unit shown in FIG. 1, the broken lines of each representing indeterminant lengths, the pair being shown on a ledge depicted in broken lines to represent a common installation environment;

FIG. 12 depicts a bottom perspective view of the second embodiment of the bird exclusion device shown in FIG. 11;

FIG. 13 depicts a right side view of the second embodiment of the bird exclusion device shown in FIG. 11;

FIG. 14 depicts a left side view of the second embodiment of the bird exclusion device shown in FIG. 11;

FIG. 15 depicts a front view of the second embodiment of the bird exclusion device shown in FIG. 11;

FIG. 16 depicts a rear view of the second embodiment of the bird exclusion device shown in FIG. 11;

FIG. 17 depicts a bottom view of the second embodiment of the bird exclusion device shown in FIG. 11;

FIG. 18 depicts a top view of the second embodiment of the bird exclusion device shown in FIG. 11;

FIG. 19 depicts a top perspective view of a bird exclusion device in accordance with a third embodiment of the present invention, the third embodiment comprising a second extender in use with the base unit shown in FIG. 1, the broken lines of each representing indeterminant lengths, the pair being shown on a ledge depicted in broken lines to represent a common installation environment;

FIG. 20 depicts a bottom perspective view of the third embodiment of the bird exclusion device shown in FIG. 19;

FIG. 21 depicts a right side view of the third embodiment of the bird exclusion device shown in FIG. 19;

FIG. 22 depicts a left side view of the third embodiment of the bird exclusion device shown in FIG. 19;

FIG. 23 depicts a front view of the third embodiment of the bird exclusion device shown in FIG. 19;

FIG. 24 depicts a rear view of the third embodiment of the bird exclusion device shown in FIG. 19;

FIG. 25 depicts a bottom view of the third embodiment of the bird exclusion device shown in FIG. 19;

FIG. 26 depicts a top view of the third embodiment of the bird exclusion device shown in FIG. 19;

FIG. 27 depicts a top perspective view of a mid-extender, an accessory for use with any embodiment of the present invention;

FIG. 28 depicts a top perspective view of the mid-extender of FIG. 27 installed between the first extender of

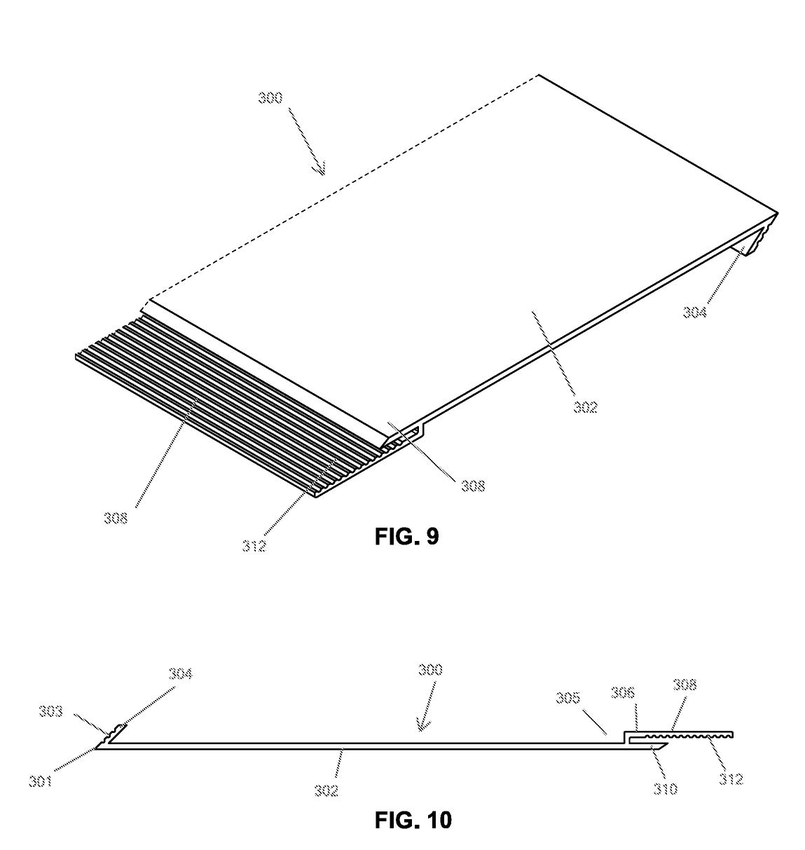

FIG. 9 and the base unit of FIG. 1, the broken lines of each representing indeterminant lengths, the pair being shown on a ledge depicted in broken lines to represent a common installation environment;

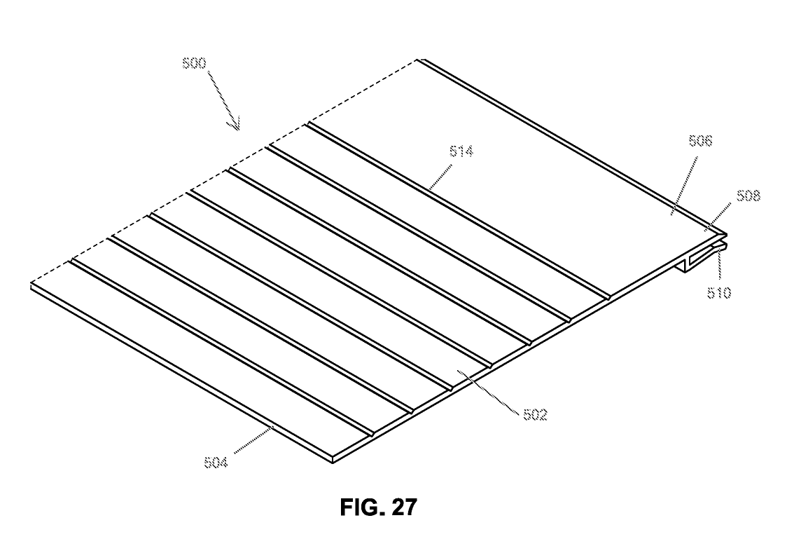

FIG. 29 depicts a right side view of the mid-extender of FIG. 27;

FIG. 30 depicts a top perspective view of an end piece, an accessory for use with any embodiment of the present invention;

FIG. 31 depicts a side view of the end piece of FIG. 30;

FIG. 32 depicts a top perspective view of a connector piece, an accessory for use with any embodiment of the present invention;

FIG. 33 depicts a side view of the connector piece of FIG. 32;

FIG. 34 depicts a perspective view of the end piece and connector installed on a bird exclusion device of the type shown in FIG. 1.

### DETAILED DESCRIPTION

In the following are described the preferred embodiments of the BIRD EXCLUSION DEVICE of the present invention. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose. Where like elements have been depicted in multiple embodiments, identical reference numerals have been used in the multiple embodiments for ease of understanding.

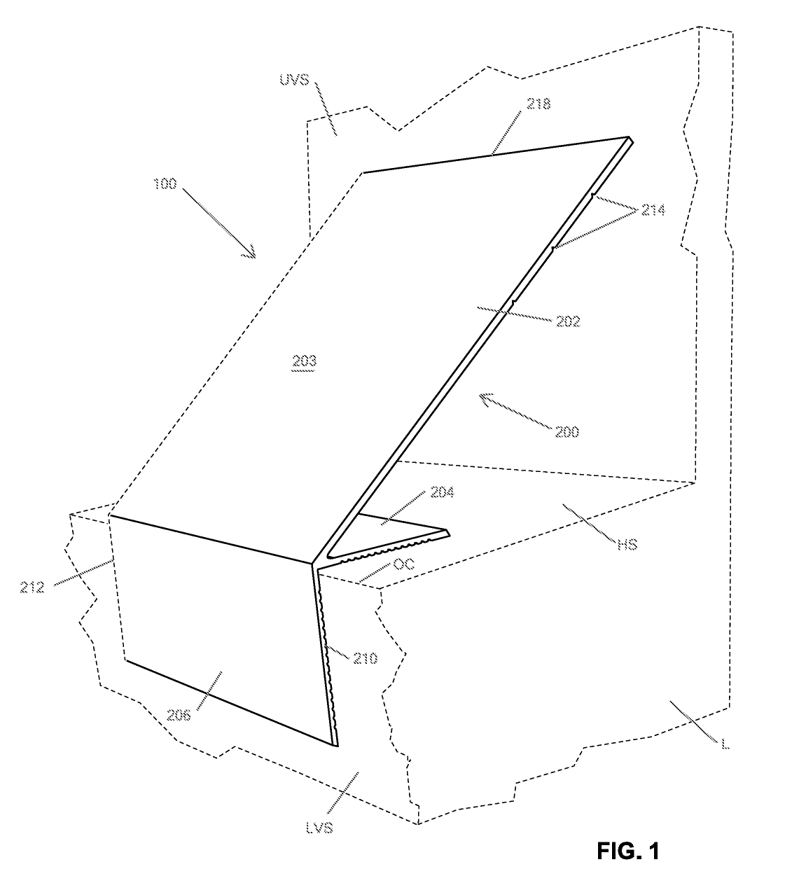

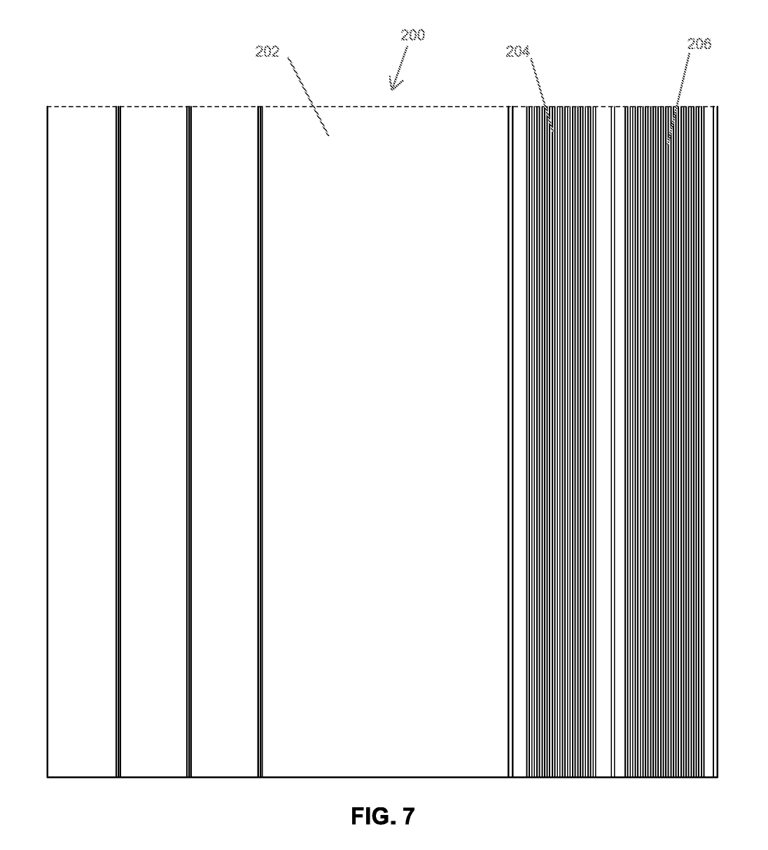

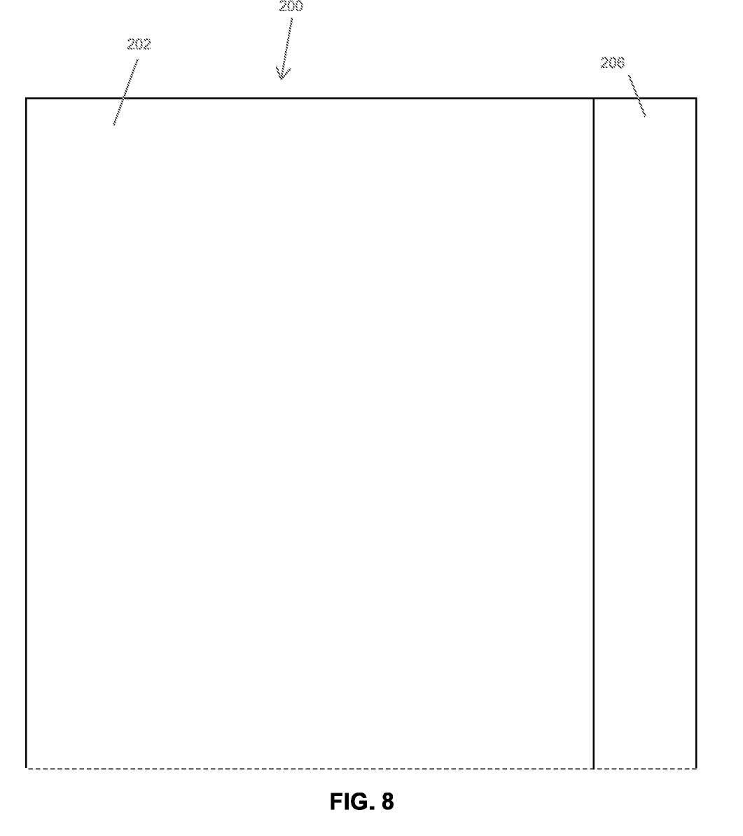

Details of the invention may be appreciated by considering the entirety of the submission. However, in accordance with a first embodiment of the present invention, a bird exclusion device 100 comprises a base unit 200 as shown in FIGS. 1-8, and in FIG. 1 upon a ledge L depicted in broken lines to represent a common installation environment.

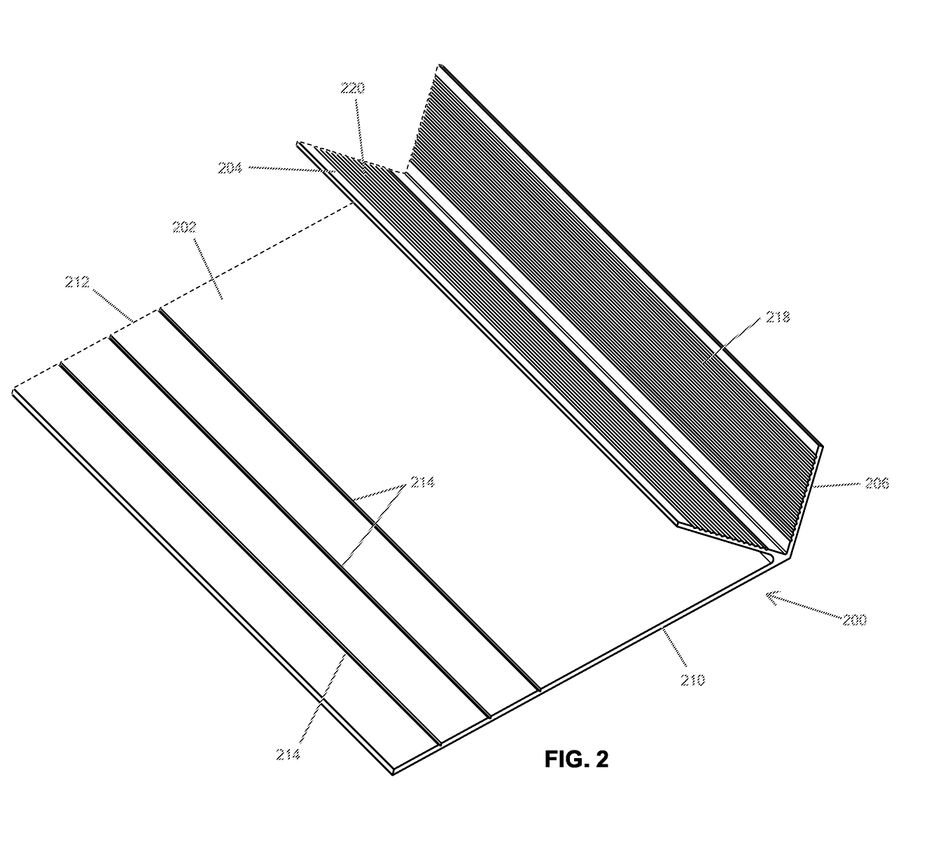

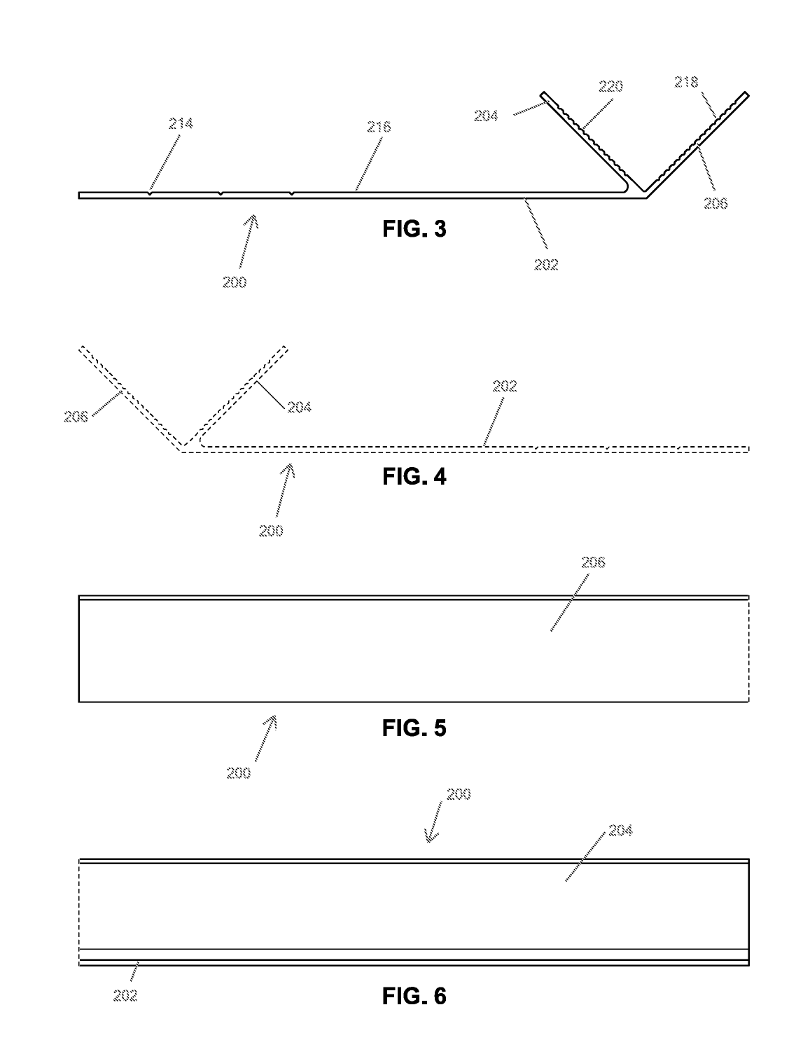

The base unit 200 is comprised of an elongate member 202, a foundation member 204, and a frontal member 206, all being planar and extending from a common junction 208. The frontal member 206 and foundation member 204 generally extend at an angle of 90-degrees from one another with the elongate member 202 extending at a 45-degree angle from the foundation member 204 in a direction away from the frontal member 206. This relationship is best shown in FIG. 3. Other angles, particularly for the elongate member 202, such as those between approximately 15-degrees to approximately 75-degrees, are also contemplated. When considering the angle of the elongate member 202 one will appreciate that the member should not be so horizontal that a bird can successfully land on it.

The base unit 200, and particularly the elongate member 202 thereof, extends from a first edge 210 to a second edge 212. In preferred embodiments this length ranges between approximately 36 inches and 60 inches, with most preferred lengths of 36 inches, 48 inches, and 60 inches. In practice, these lengths can depend on the installation requirements. For example, if a length of 68 inches is required for a particular application, the base unit 200 can be made to 68 inches long rather than piecing together two units. Or a longer unit can be cut to 68 inches using conventional tools, such as various hand saws. In FIGS. 1-8 the base unit 200 is shown with its second edge 212 in broken lines to identify indeterminant length.

The frontal member 206 extends away from the common junction 208 approximately 1 inch to 4 inches in preferred embodiments, and 2 inches in the most preferred embodiment. Similarly, the foundation member 204 extends away from the common junction 208 approximately 1 inch to 4 inches in preferred embodiments, and 2 inches in the most preferred embodiment. In preferred embodiments, the frontal member 206 and foundation member 204 have lengths matching that of the elongate member 202. Finally, the elongate member 202 extends in depth, i.e. away from the common junction 208, approximately 7 inches to 10 inches in preferred embodiments, and approximately 8.5 inches to 9 inches in the most preferred embodiment.

The base unit 200 may be manufactured from a variety of materials, with the most preferred materials including those that are relatively stiff, light, and unyielding. The preferred material is synthetic plastic polymer, and specifically polyvinyl chloride (PVC).

Preferably the base unit 200 will be manufactured in an extrusion process with very little to no post extrusion tooling. Thus, the base unit 200 preferably has a consistent cross-section throughout its length.

The thickness of the elongate member 202, the foundation member 204, and the frontal member 206 of the base unit 200 may vary, but a preferred thickness of each is between 0.085 inches and 0.115 inches, with a most preferred thickness of 0.1 inches. In preferred embodiments each of the three members, the elongate member 202, the foundation member 204, and the frontal member 206, all have the same thickness. In other embodiments they do not.

It will be appreciated that the area of the common junction 208 may be “built-up” to a greater thickness than any or all of the elongate member 202, the foundation member 204, or the frontal member 206, to meet strength requirements, preventing the various members from snapping off or bending at that critical convergence. This is particularly true in the junction between the foundation member 204 and elongate member 202, as shown most clearly in FIG. 3.

The elongate member 202 includes score lines 214 running between, and perpendicular to, the first edge 210 and second edge 212 on its underside 216. The score lines 214 enable an installer to run a utility knife or other cutting implement along the score line to cut the elongate member to a depth suitable for the installation condition. For example, the score lines 214 may be set at 0.5 inch intervals to permit the elongate member 202 to be easily and quickly cut to any depth meeting one of those 0.5 inch intervals. Other intervals may also be used, such as 1 inch or 0.25 inch intervals.

Referring back to FIG. 1, it will be appreciated that the base 200 may be installed on the ledge L of a building or other structure such that the common junction 208 rests against the outside corner OC of the ledge L with the foundation member 204 resting on the ledge's horizontal surface HS and the frontal member 206 extending down along the ledge's lower vertical surface LVS. The elongate member 202 then extends at its angle, typically 45-degrees, upward and inward to meet with the upper vertical surface UVS of the ledge L, thus preventing birds from alighting on the ledge, and particularly its horizontal surface HS. Rather, birds will land on the sloping elongate member 202 and slide off. It will be appreciated that front surface 203 of the elongate member 202 is preferably finished smooth to avoid any areas where a bird might gain purchase.

It will also be appreciated that birds cannot gain purchase at the junction of the foundation member 204 and the ledge L because the frontal member 206 eliminates any gap that may be formed there had the frontal member not been included.

To affix the base member 200 to the ledge L, the installer will typically glue the foundation member 204 and frontal member 206 to the ledge with suitable adhesives, for example those suitable for affixing plastic to wood or plastic to concrete. The undersides of each member 218, 220 may include a surface treatments increasing the surface area thereof, for example grooves, such as those formed by a trowel in ceramic tile installation, to aid with adherence of the adhesive. Other techniques include driving anchoring elements, such as nails or other anchors, through the base member 200 and into the substrate below. Alternatively, the base member 200 may be pre-drilled to avoid cracking or splintering.

The base member 200 may be so affixed and the job complete. In most applications, however, it will be preferred to include an extender to customize the depth of the device against the upper vertical surface UVS of the ledge L as in the field such depths vary greatly, and cannot all be accounted for using the score lines 214.

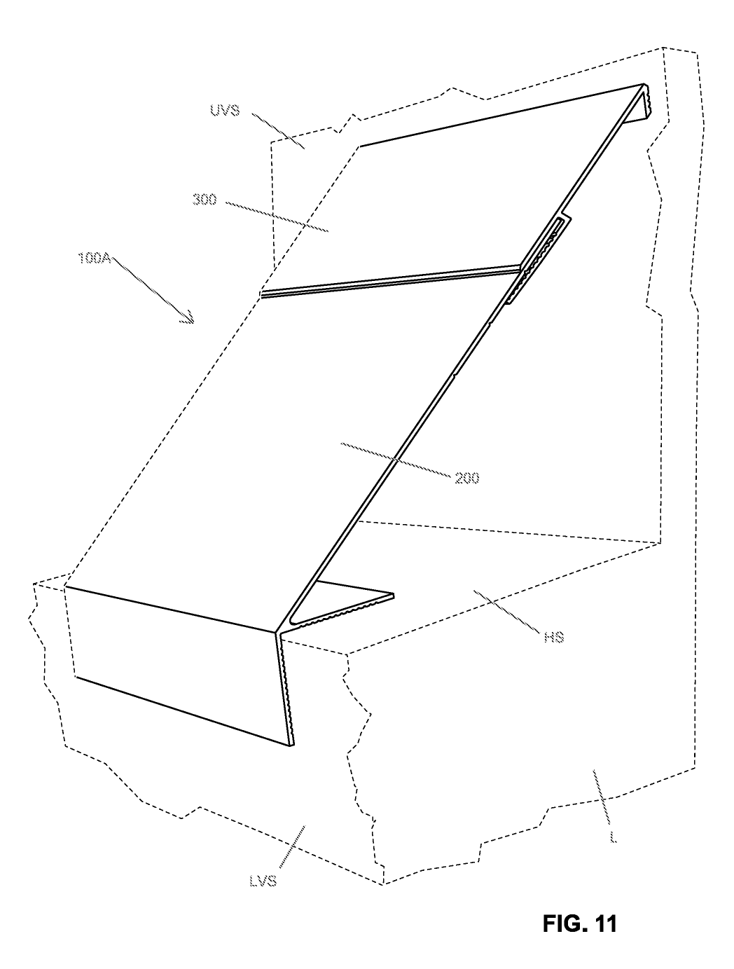

One exemplary extender for optional use with base unit 200, namely a first extender 300, is shown in a top perspective view in FIG. 9. The first extender comprises a main portion 302 extending between an end member 304 and a connection portion 306. The end member 304 extends from a first end 301 of the main portion 302 at an angle, preferably being the difference between the angle of the respective elongate member 202 of base unit 200 and 90-degrees, such that the two angles are complimentary. For example, an elongate member 202 angle of 45-degrees will result in an end member 304 angle of 45-degrees while an elongate member angle of 60-degrees will result in an end member angle of 30-degrees. In this regard, the outside surface 303 of the end member 304 will lie parallel to the upper vertical surface UVS of a ledge L upon which the bird exclusion device is installed. This relationship is best shown in FIG. 11, depicting a bird deterrent device 100A.

The connection member 306, at a second end 305 of the main member 302, comprises a pair of opposed fingers, a first finger 308 and a second finger 310. The first finger 308 is approximately three times the length of the second finger 310, and itself ranges from approximately 1 inch to 2 inches with 1.5 inches being most preferred. This leaves the second finger 310 at 0.33 inches to 0.67 inches with a most preferred length being 0.5 inches.

The length of the end member 304 is preferably between 0.25 inches and 0.5 inches with a preferred length of approximately 0.33 inches, measured from the first end 301 to the distal end 307 of the second finger 310. It will be appreciated that this distal end 307 is tapered, with the inside edge (that toward the first finger 308 side) being longer.

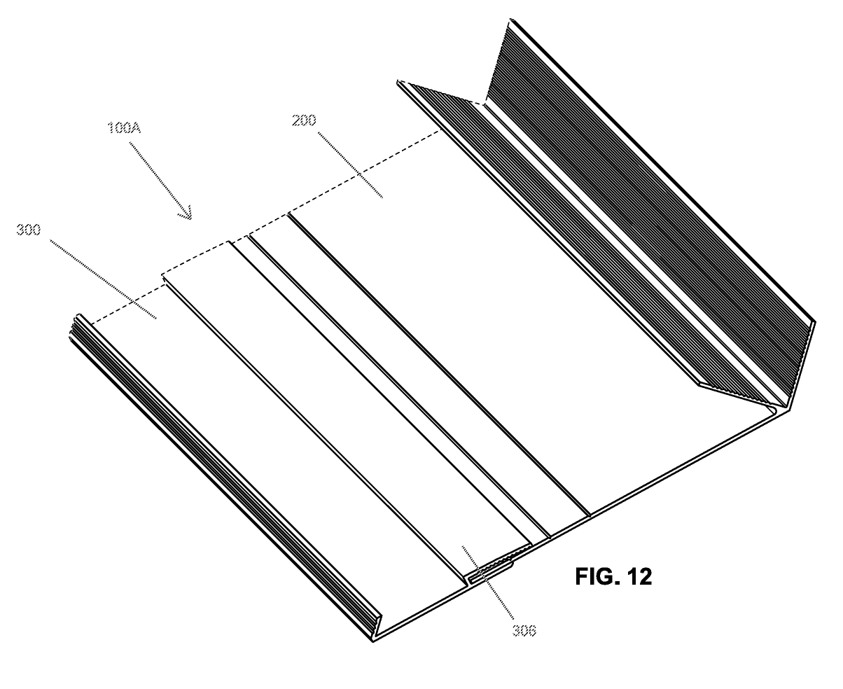

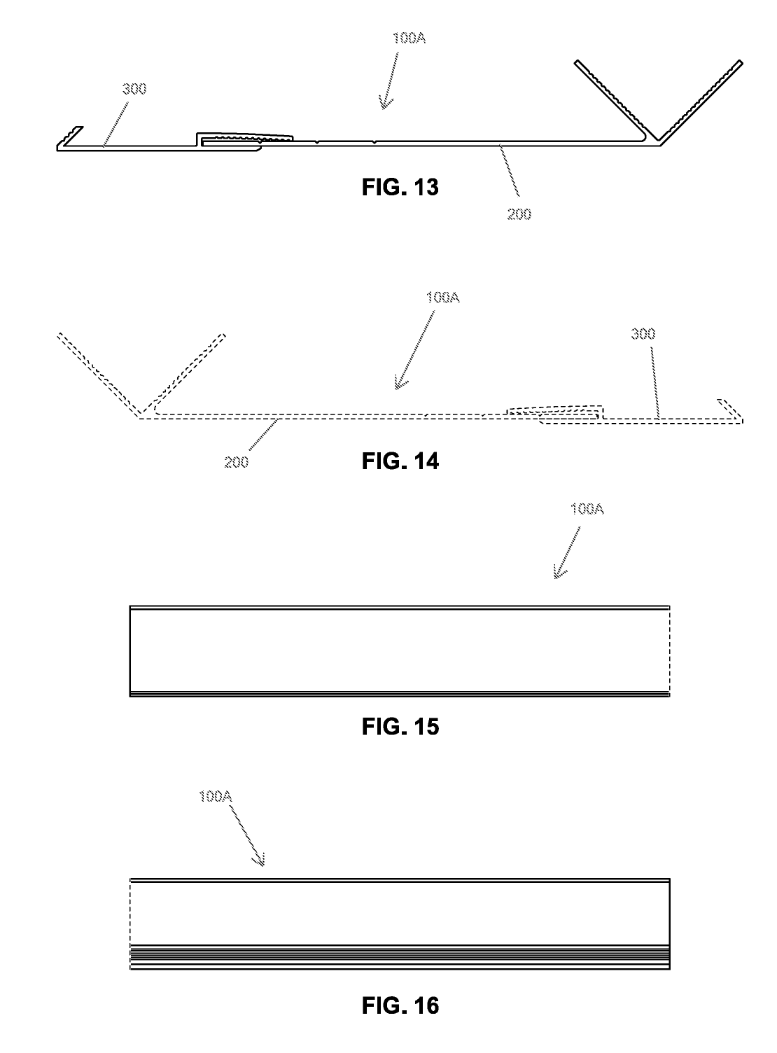

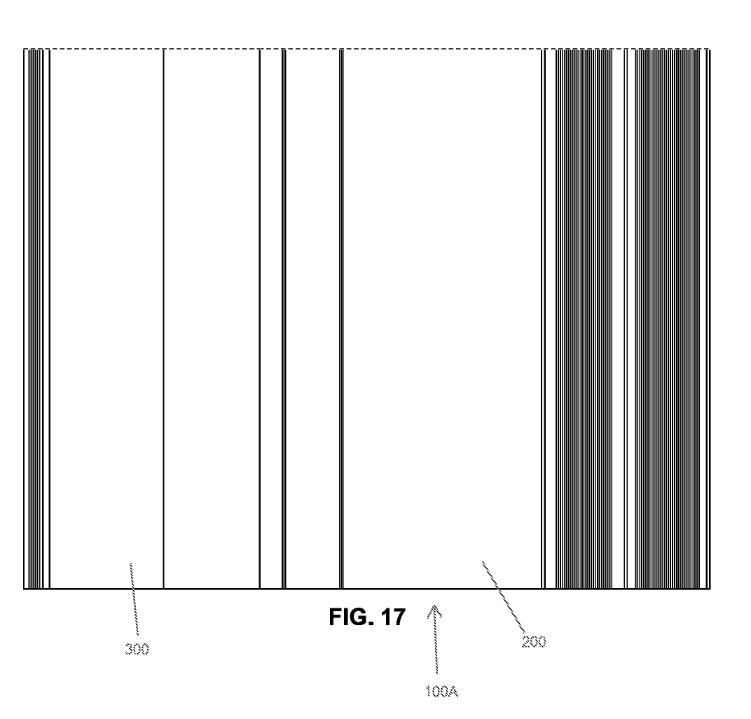

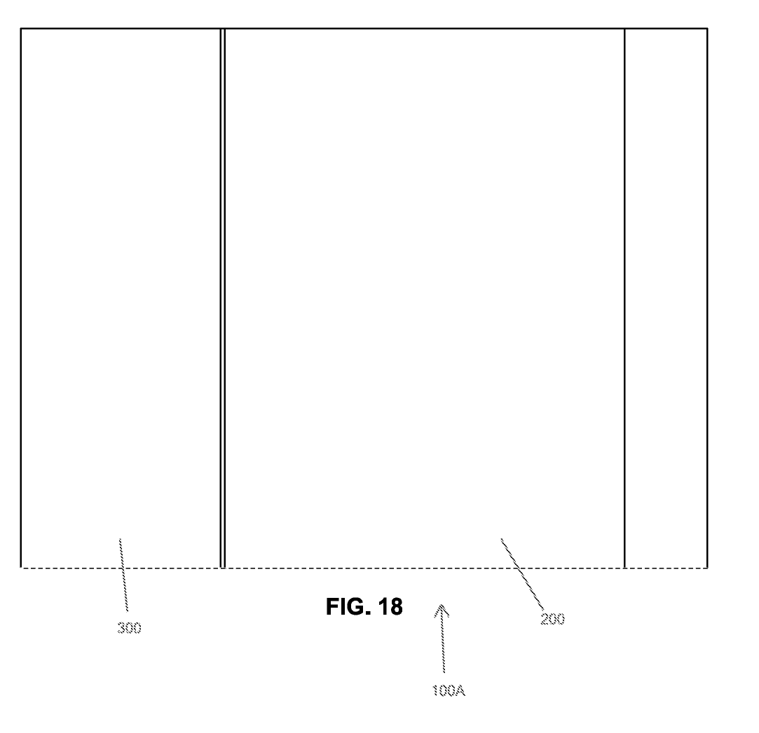

The gap between the first finger 308 and second finger 310 is generally equal to the thickness of the elongate member 202 such that the distal end of the elongate member, either the natural distal end 218 (see FIG. 1) or one formed from reducing its depth via a score line 214, fits within the fingers 308, 310. This detail is shown in FIGS. 11-14.

To install the first extender 300 on a base unit, such as base unit 200, an installer applies a suitable adhesive to the interior surface 312 of the first finger 308, which may include surface treatments as discussed with reference to the foundation member 204 and frontal member 206 above, and then abuts the first finger 308 along the back edge of the elongate member 202 at an angle such that the second finger 310 is below an imaginary extension line formed by a projection of the elongate member. The installer then rotates the entire first extender 300 to bring the second finger 310 in front of the projection, essentially placing the first and second fingers 308, 310 parallel to the elongate member 202. The first extender 300 can then be slid to its final position, as shown in FIGS. 11-14, with portions of the elongate member 202 completely filling the space between the first and second fingers 308, 310.

To finish the installation, the installer may then adhere the outside surface 303 of the end member 304 to the upper vertical surface UVS of the ledge L. It will be appreciated that the end member 304 may include surface treatments to aid in adherence of the adhesive, as discussed with reference to other elements above.

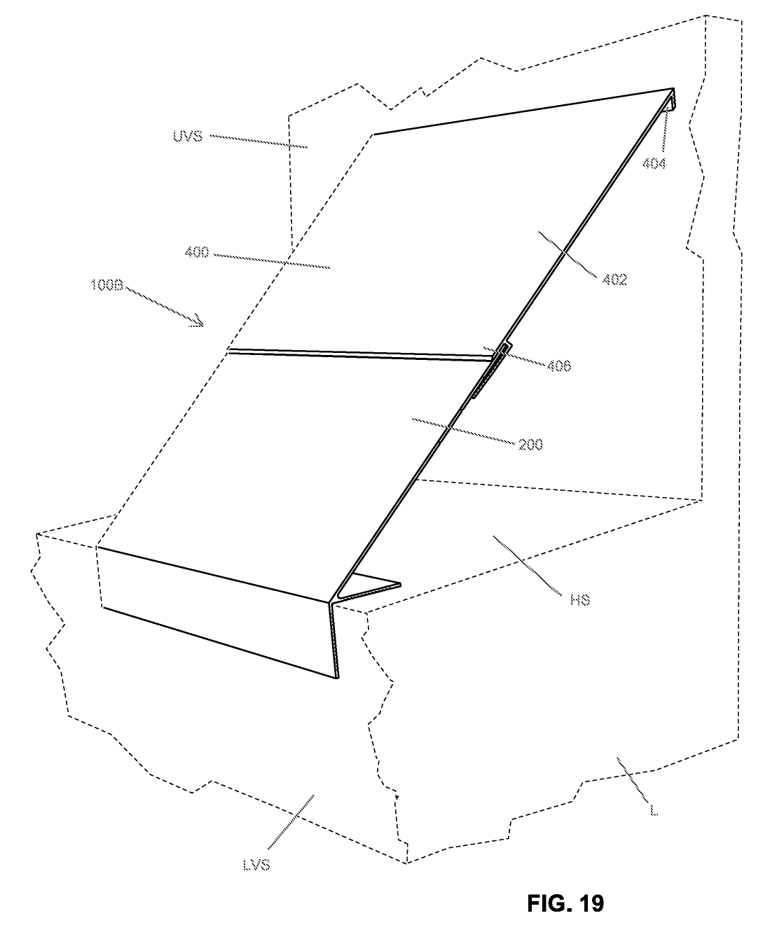

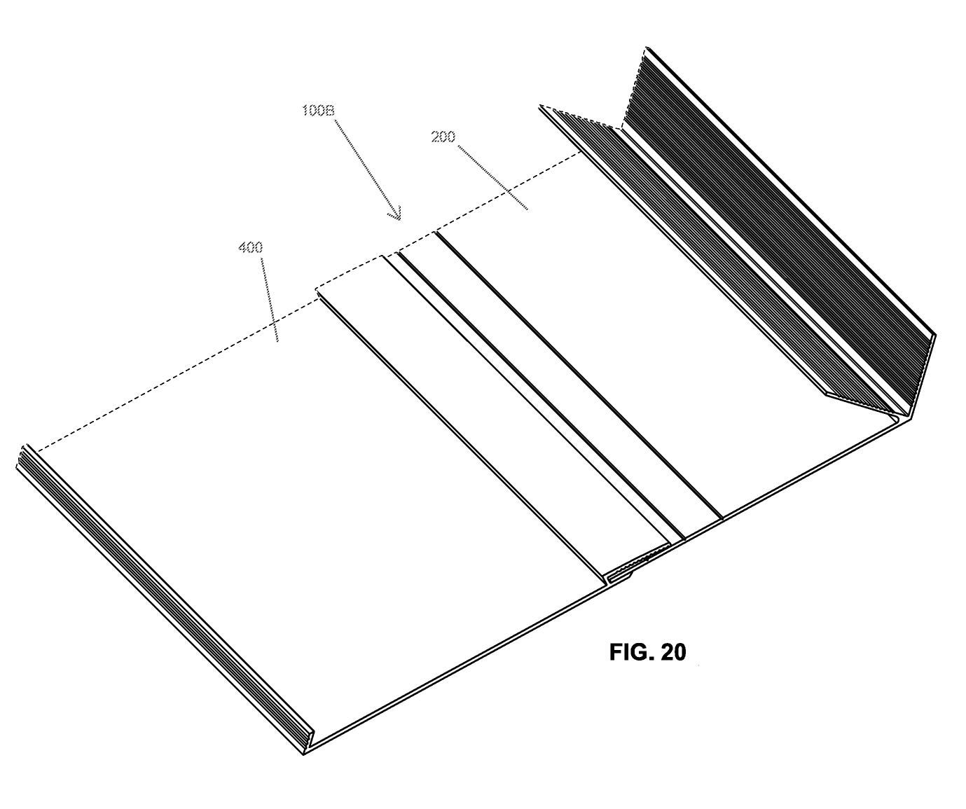

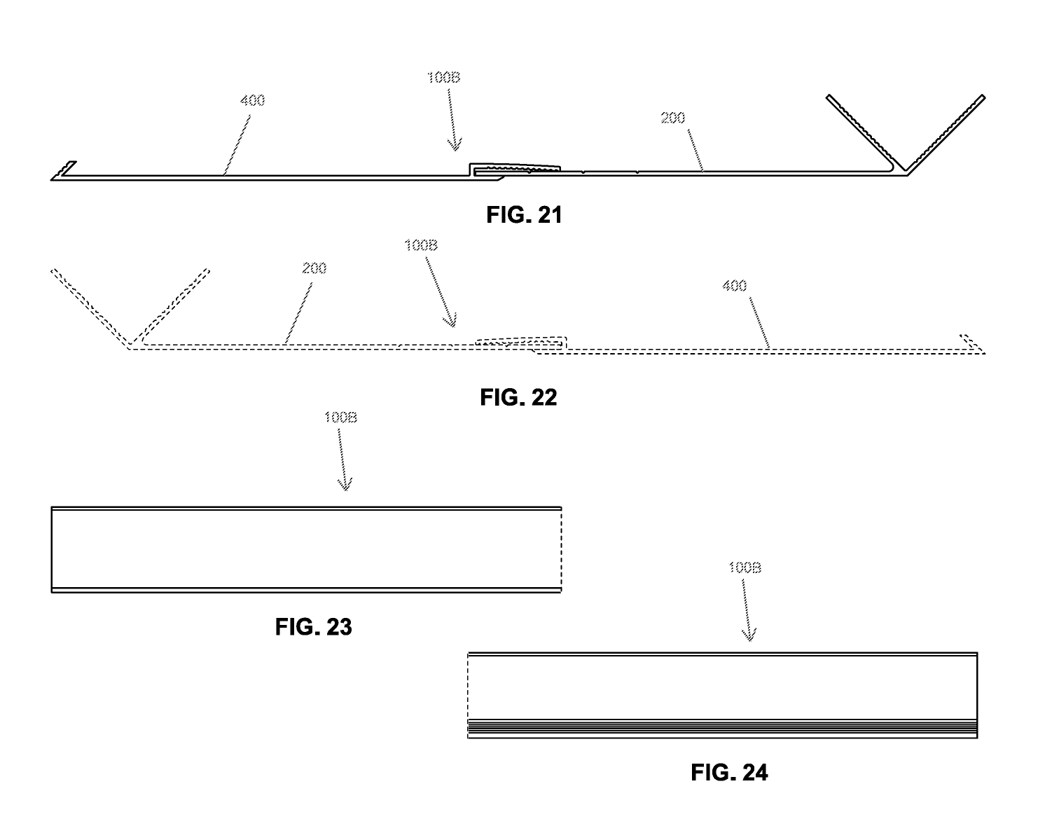

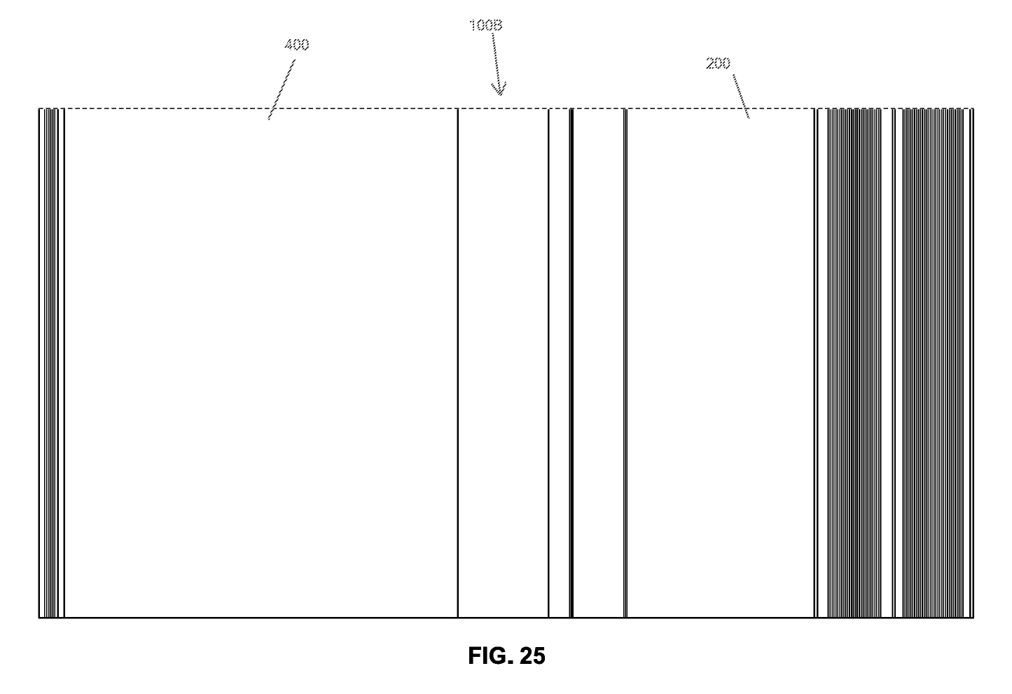

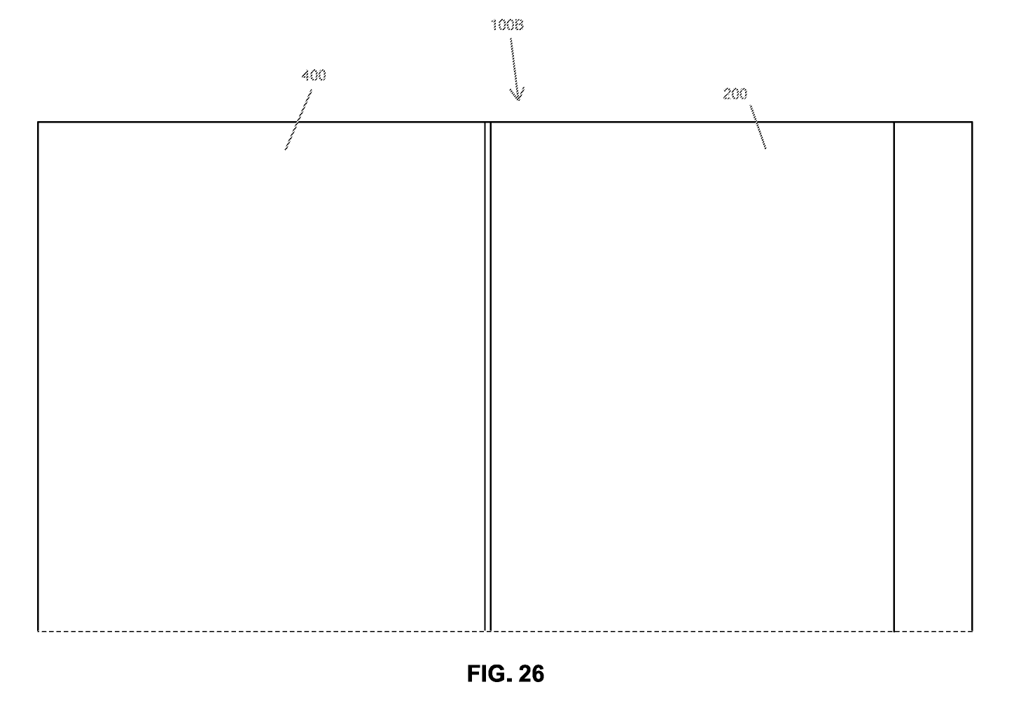

A second exemplary extender for optional use with base unit 200, namely a second extender 400, is shown in a top perspective view in FIG. 19. The second extender is configured in a manner similar to that of the first extender 300, but is deeper in depth. That is, the main portion 402 extending between an end member 404 and a connection portion 406, is longer than the main member 302 of the first extender. In addition to FIG. 19, additional details of the second extender 400 may be gleaned from FIGS. 20-26.

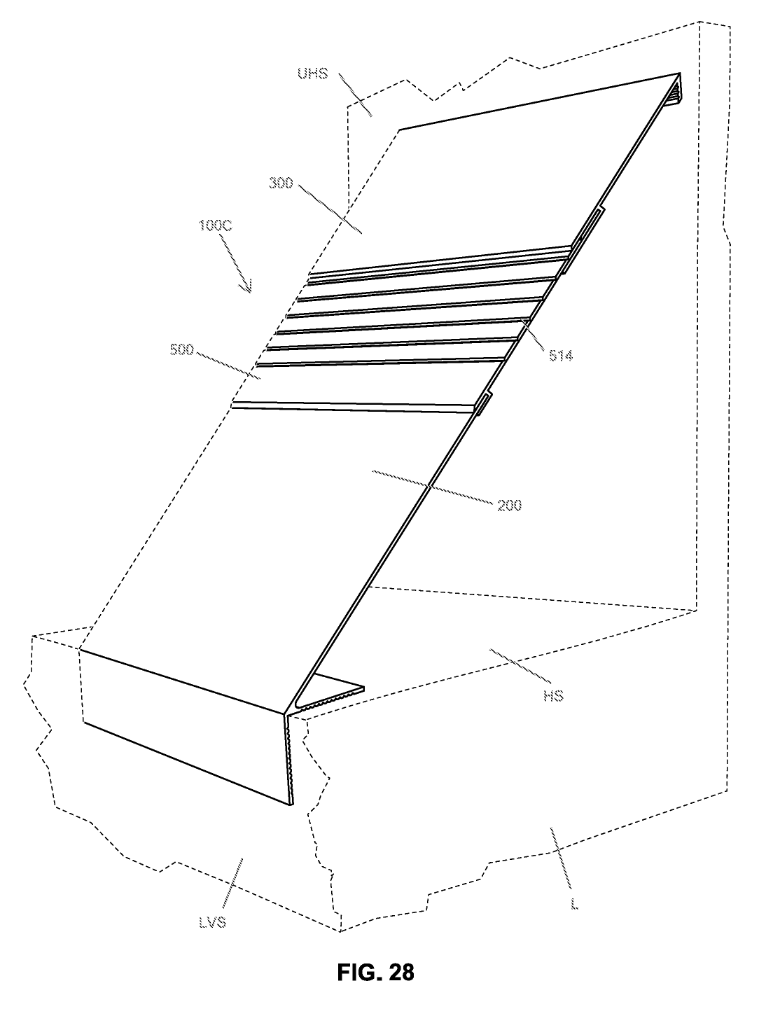

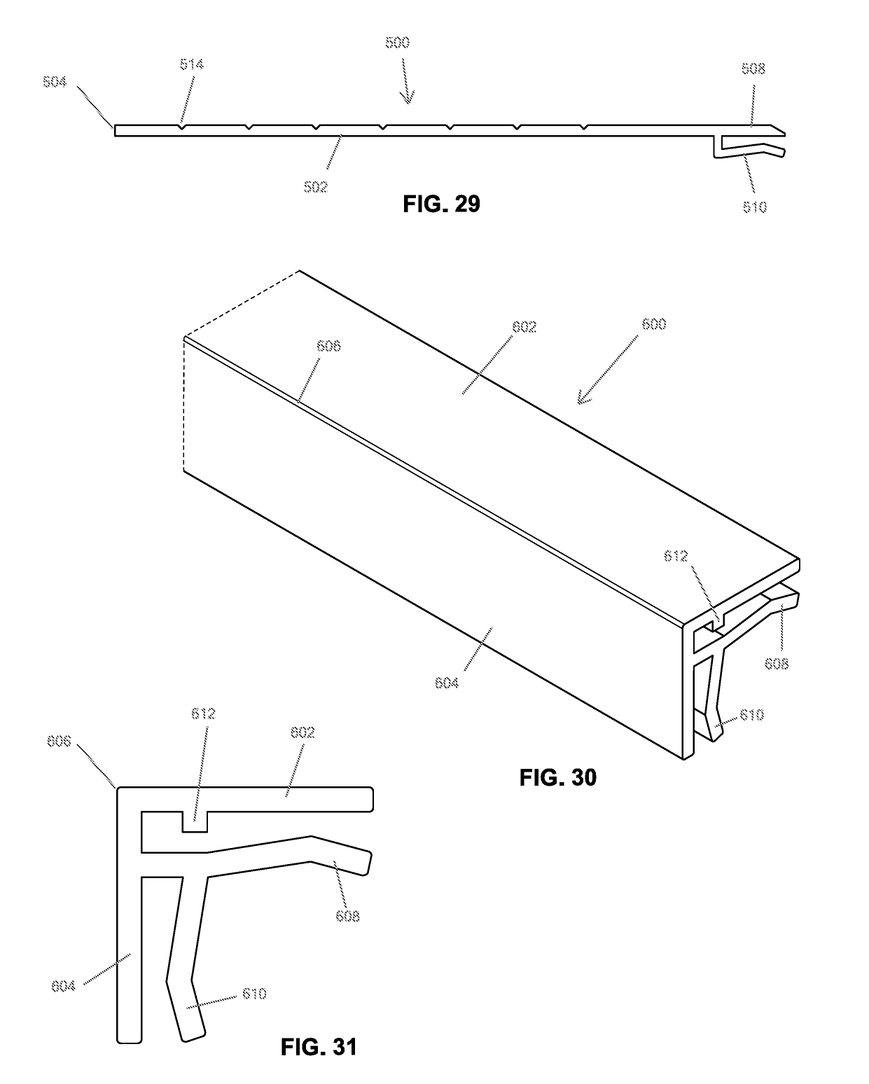

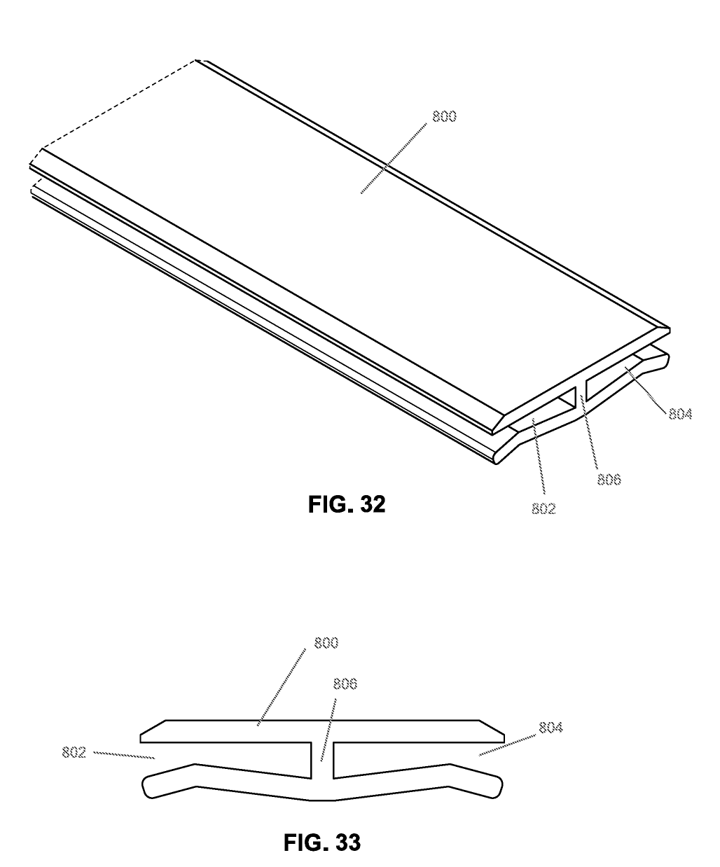

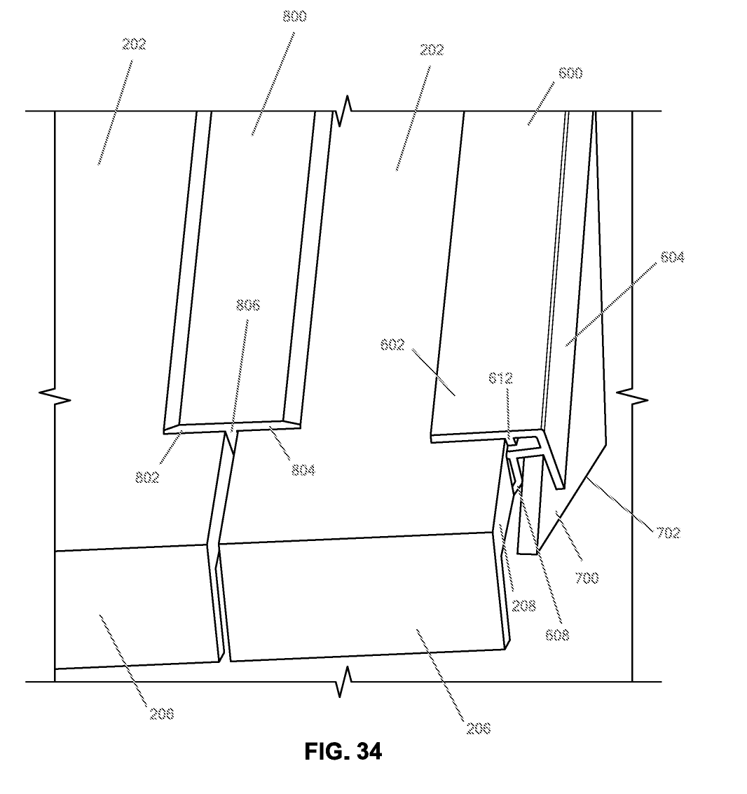

FIG. 27 depicts a top perspective view of a further accessory for use with any of the foregoing embodiments of the invention, the accessory being a mid-extender 500. As shown in FIG. 28, the mid-extender 500 may be place between the base unit 200 and an extender, in this case the first extender 300, to provide additional overall depth of an installed bird exclusion device 100C.

The mid-extender 500 includes a main portion 502 extending between an end 504 and a connection portion 506, the connection portion comprising a pair of opposed fingers, a first finger 508 and a second finger 510.

The gap between the first finger 508 and second finger 510 is generally equal to the thickness of the elongate member 202 such that the distal end of the elongate member, either the natural distal end 218 (see FIG. 1) or one formed from reducing its depth via a score line 214, fits within the fingers 508, 510. This detail is shown in FIGS. 28.

The main portion 502 of the mid-extender 500 includes score lines 514 similar to those score lines 214 of the base unit 200 discussed earlier.

Another accessory that may be provided, namely an end piece 600, is shown in FIGS. 30 and 31. End piece 600 comprises a first member 602 and a second member 604, each generally rectangular, and meeting at a spine 606 such that they are arranged 90-degrees from one another. Within the interior space between the first and second members 602, 604, are provided first and second fingers, 608, 610. It will be appreciated that first finger 608 and first member 602 form a gap within which the elongate member 202 may be placed while second finger 610 and second member 604 form a gap within which a triangular member 700 may be inserted such as shown in FIG. 34 such that a base 702 thereof rests on the HS (not shown in FIG. 34). The triangular member 700 prevents birds, rodents, and the like from nesting beneath the bird deterrent device 100. Moreover, the triangular member 700 presents a clean appearance in those instances where the side of the bird deterrent device 100 is exposed.

End piece 600 includes a limit stop 612 extending downwardly from the first member 602. When the elongate member 202 is inserted into the gap between first member 602 and first finger 608, the limit stop 612 prevents the elongate member from extending too deep toward the spine 606.

Yet another accessory that may be provided, namely a connector 800, is shown in FIGS. 32 and 33. The connector 800 is designed to connect the elongate members 202 arranged side-by-side. In this manner, a series of elongate members 202 may be installed on a ledge with a length longer than any base unit 200. For example, given a base unit length of 48 inches and a ledge of 40 feet, approximately 10 base units 200 may be connected in series with connectors 800 to cover the entire ledge.

To achieve this result, the connectors 800 each include a first pair of fingers 802 and a second pair of fingers 804 separated by a web 806. As shown in FIG. 33, this arrangement provides a component which is similar to an I-beam.

While other techniques and materials may be utilized, it will be appreciated that the end piece 600 and connector 800 may both be extruded, preferably from a synthetic plastic polymer. The lengths of end piece 600 and connector 800 may be any length that is less than that of elongate member 202, and may be field cut to match the length necessary.

While not shown, it will be further appreciated that the end piece 600 and connector 800 may also be used with embodiments of the invention employing extenders, such as bird deterrent devices 100A, 100B, or 100C. In those cases, the first finger 608 and first member 602 may be spread apart to fit over the meeting of the base unit 200 and respective extender. Likewise, the first pair of fingers 802 and second pair of fingers 804 may be similarly spread.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

I claim:

1. A bird exclusion device comprising:
a base unit, said base unit comprising an elongate member, a foundation member, and a frontal member, all being planar and extending from a common junction;
said foundation member and said frontal member forming an angle of approximately 90-degrees between one another.

2. The bird exclusion device of claim 1, wherein said elongate member extends at an angle from said foundation member of between approximately 15-degrees and approximately 75-degrees.

3. The bird exclusion device of claim 1, wherein said base unit has a length with a consistent cross-section throughout the length.

4. The bird exclusion device of claim 1, wherein said elongate member, said foundation member, and said frontal member each have approximately equal thickness, with the common junction being built-up to a greater thickness.

5. The bird exclusion device of claim 1, wherein said elongate member has a depth and said foundation member and said frontal member have depths less than that of said elongate member.

6. The bird exclusion device of claim 5, wherein said frontal member and said foundation member have different depths.

7. The bird exclusion device of claim 1, further comprising an extender, said extender comprising a main portion extending from a connection portion, said connection portion adapted to connect to said elongate member.

8. The bird exclusion device of claim 7, wherein said connection portion comprises a pair of opposed fingers.

9. The bird exclusion device of claim 7, wherein said elongate member extends at a first angle from said foundation member, and said end member further comprises an end member, said end member angled relative to said main portion at a second angle, said first angle and said second angle having a sum equaling 90-degrees or approximately 90-degrees.

10. The bird exclusion device of claim 1, wherein said base unit is formed from synthetic plastic polymer.

11. The bird exclusion device of claim 1, wherein each of said foundation member and said frontal member include undersides having surface treatments increasing the surface area thereof.

12. The bird exclusion device of claim 1, wherein said base unit consists of the elongate member, the foundation member, and the frontal member.

13. The bird exclusion device of claim 1, wherein said elongate member extends at an angle from said foundation member of approximately 45-degrees.

14. A bird exclusion device comprising:
a base unit, said base unit having a length, with a consistent cross-section throughout the length;
said base unit comprising an elongate member, a foundation member, and a frontal member, all being planar and extending from a common junction;
said foundation member and said frontal member forming an angle of approximately 90-degrees between one another;
said elongate member extending at an angle from said foundation member of between approximately 15-degrees and approximately 75-degrees.

15. The bird exclusion device of claim 14, wherein said elongate member, said foundation member, and said frontal member each have approximately equal thickness, with the common junction being built-up to a greater thickness.

16. The bird exclusion device of claim 14, further comprising an extender, said extender comprising a main portion extending between an end member and a connection portion, said connection portion comprising a pair of opposed fingers adapted to connect to said elongate member.

17. A method of forming a bird exclusion device, said method comprising extruding a material to form a base unit, the base unit comprising an elongate member, a foundation member, and a frontal member, all being planar and extending from a common junction, the foundation member and the frontal member forming an angle of approximately 90-degrees between one another.

18. The method of forming a bird exclusion device of claim 15, wherein the material is synthetic plastic polymer.

19. The method of forming a bird exclusion device of claim 16, wherein the elongate member, foundation member, and frontal member each have approximately equal thicknesses with the common junction being built-up to a greater thickness.
